(19) United States
(12) Patent Application Publication
(10) Pub. No.: US 2022/0115802 A1
(43) Pub. Date: Apr. 14, 2022

(54) Terminal

(71) Applicant: I-PEX Inc., Kyoto (JP)

(72) Inventor: Kenya Ando, Shizuoka (JP)

(73) Assignee: I-PEX Inc., Kyoto (JP)

(21) Appl. No.: 17/407,693

(22) Filed: Aug. 20, 2021

(30) Foreign Application Priority Data
Oct. 9, 2020 (JP) 2020-170909

(51) Int. Cl. H01R 13/187; H01R 13/631

(52) U.S. Cl. CPC H01R 13/187; H01R 13/631

(57) ABSTRACT

A terminal includes a body and an elastic contact plate. The body includes a cylindrical shape into which a mating terminal is inserted, and includes, in an inner wall, a contact region that comes into contact with the mating terminal. The elastic contact plate presses the mating terminal against the contact region. A plurality of grooves that extends in a second direction intersecting a first direction in which the mating terminal is inserted is formed in the contact region.

### CROSS-REFERENCE TO RELATED APPLICATION

This application claims the benefit of Japanese Patent Application No. 2020-170909, filed on Oct. 9, 2020, the entire disclosure of which is incorporated by reference herein.

### FIELD

The present disclosure relates to a terminal.

### BACKGROUND

Digitalization in automobiles has been driven, and an increase in the number of poles due to an increase in the number of electric wiring lines, and downsizing due to an increase in the number of electronic components have been demanded in connectors.

Unexamined Japanese Patent Application Publication No. 2014-063662 discloses a connector terminal a composite coating layer including a region in which tin is exposed to an outermost surface, and a region in which a copper-tin alloy is exposed to the outermost surface is formed on a base material surface in a region including a contact that comes into contact with another conductive member.

In the connector terminal disclosed in Unexamined Japanese Patent Application Publication No. 2014-063662, adhesion between tin layers with wide exposed regions and the digging wear of the tin layers easily occur when sliding occurs on a surface of the composite coating layer in the case of electrical connection with the other conductive member. The connector has a problem in that, as a result, the frictional resistance of the surface of the composite coating layer is increased, whereby terminal insertion force is increased. When the number of poles is increased in a connector terminal, an increase in terminal insertion force precludes an operator from performing connection by hand, whereby it becomes necessary to attach a lever to the connector. A reduction in the insertion force of the connector terminal enables the number of poles to be increased to enable a reduction in the number of connectors, and enables replacement of a lever-type connector with a usual connector without a lever, and therefore, the connector can be downsized. Therefore, a terminal into which another conductive member can be inserted with relatively low force is demanded.

The present disclosure was made under the above-described circumstances, with an objective to provide a terminal into which a mating terminal can be inserted with relatively low force.

### SUMMARY

In order to achieve the objective described above, a terminal according to a first aspect of the present disclosure includes:

a body that includes a cylindrical shape into which a mating terminal is inserted, and includes, in an inner wall, a contact region that comes into contact with the mating terminal; and an elastic contact plate that presses the mating terminal against the contact region, wherein a plurality of grooves that extends in a second direction intersecting a first direction in which the mating terminal is inserted is formed in the contact region.

It is preferable that the plurality of grooves is arranged at an equal spacing.

It is preferable that the plurality of grooves is arranged in parallel to each other.

It is preferable that a spacing between the grooves is greater than a width of each of the grooves.

It is preferable that a cross section orthogonal to the first direction in the contact region intersects one or two of the grooves.

It is preferable that the plurality of grooves extends in a direction sloping at an angle of 30 degrees or more and 60 degrees or less with respect to the first direction.

It is preferable that the contact region includes a portion in which any of the grooves is not formed in an end closest to an inlet of the body into which the mating terminal is inserted.

It is preferable that a length of the portion in which any of the grooves is not formed in the end in the first direction is not less than the width of each of the grooves.

It is preferable to further include a slope that is connected to the end in the contact region, guides the mating terminal to the contact region, and slopes with respect to a plane on which the contact region is formed.

It is preferable that: the contact region includes a first contact region and a second contact region into which the contact region is divided by a virtual line extending in the first direction;

a plurality of first grooves extending in the second direction is formed on a surface of the first contact region; and

a plurality of second grooves, formed to be line-symmetric, across the virtual line as a symmetry axis, with respect to the plurality of first grooves formed on the first contact region, is formed on the second contact region.

It is preferable that at least one of the mating terminal or the contact region includes a conductive coating layer.

In accordance with the present disclosure, the plurality of grooves that extends in the second direction intersecting the first direction in which the mating terminal is inserted is formed on the contact region. Therefore, the terminal into which the mating terminal can be inserted with relatively low force can be provided.

### BRIEF DESCRIPTION OF THE DRAWINGS

A more complete understanding of this application can be obtained when the following detailed description is considered in conjunction with the following drawings, in which:

FIG. 1 is a perspective view illustrating a terminal according to an embodiment of the present disclosure;

FIG. 2 is a top view illustrating the terminal according to the embodiment of the present disclosure;

FIG. 3 is a side view illustrating the terminal according to the embodiment of the present disclosure;

FIG. 4 is a perspective view illustrating a mating terminal according to the embodiment of the present disclosure;

FIG. 5 is a side view illustrating the mating terminal according to the embodiment of the present disclosure;

FIG. 6 is a cross-sectional view taken along the line VI-VI of FIG. 5;

FIG. 7 is a cross-sectional view taken along the line VII-VII of FIG. 2;

FIG. 8 is a cross-sectional view taken along the line VIII-VIII of FIG. 3;

FIG. 9 is a cross-sectional view taken along the line IX-IX of FIG. 3;

FIG. 10 is an enlarged cross-sectional view of a contact region according to the embodiment of the present disclosure;

FIG. 11 is a cross-sectional view for explaining a method of inserting the mating terminal into the terminal according to the embodiment of the present disclosure;

FIG. 12 is an enlarged cross-sectional view of a portion A of FIG. 11;

FIG. 13 is an enlarged cross-sectional view (1) for explaining the method of inserting the mating terminal into the terminal according to the embodiment of the present disclosure;

FIG. 14 is an enlarged cross-sectional view (2) for explaining the method of inserting the mating terminal into the terminal according to the embodiment of the present disclosure;

FIG. 15 is an enlarged cross-sectional view (3) for explaining the method of inserting the mating terminal into the terminal according to the embodiment of the present disclosure;

FIG. 16 is a view (1) illustrating a contact region according to an alternative example;

FIG. 17 is a view (2) illustrating a contact region according to an alternative example; and

FIG. 18 is a view (3) illustrating a contact region according to an alternative example.

### DETAILED DESCRIPTION

A terminal according to an embodiment for carrying out the present disclosure will be described below with reference to the drawings.

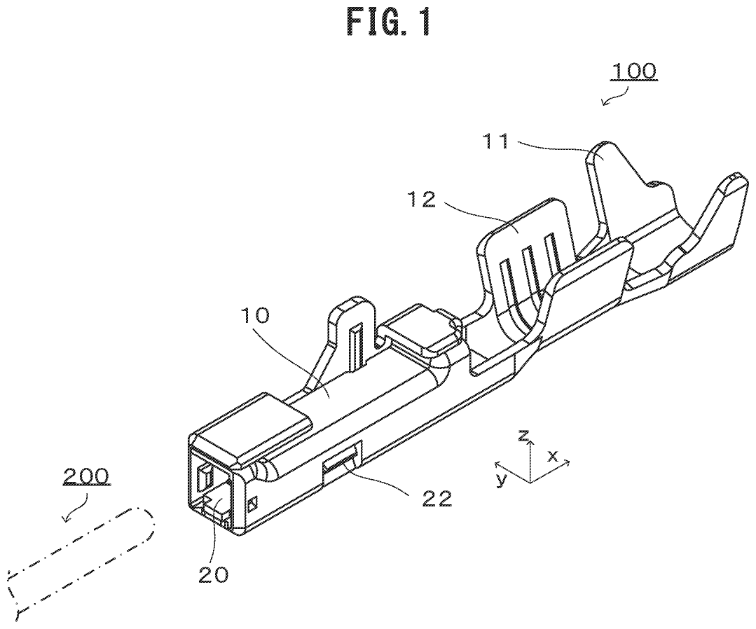

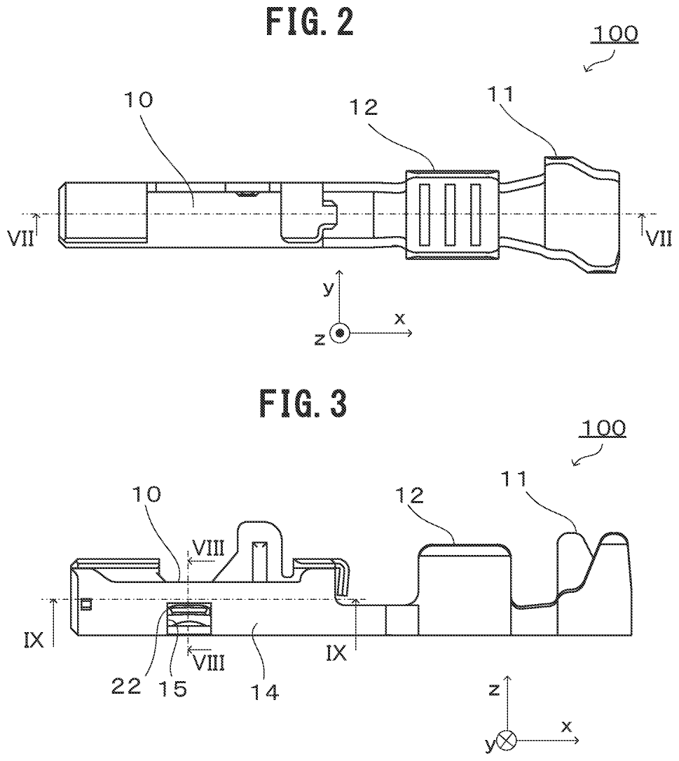

The terminal 100 according to the present embodiment includes a body 10 into which a mating terminal 200 is inserted, and an elastic contact plate 20, as illustrated in FIGS. 1 to 3. The terminal 100 is housed in a housing made of resin, and is used for electrically connecting, for example, an electronic circuit for automobile use.

For facilitating understanding, the orthogonal coordinate system in which a direction in which the mating terminal 200 is inserted into the terminal 100 is the x-direction, a direction in which the elastic contact plate 20 presses the mating terminal 200 is the z-direction, and a direction perpendicular to the x-direction and the z-direction is the y-direction is set, and reference to the orthogonal coordinate system is made as appropriate.

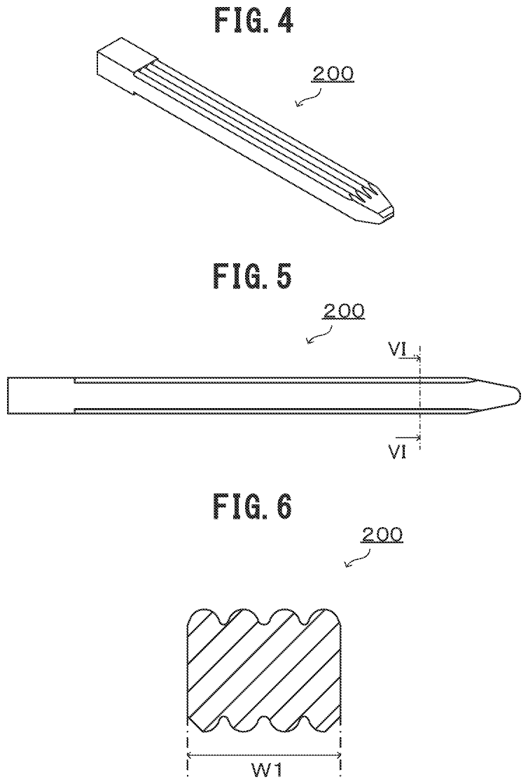

As illustrated in FIGS. 4 to 6, the mating terminal 200 is a metal rod having a width of W1, and is a male terminal on which grooves are formed in a longitudinal direction. A surface of the mating terminal 200 preferably includes a conductive coating layer. The conductive coating layer includes a tin layer or a tin alloy layer.

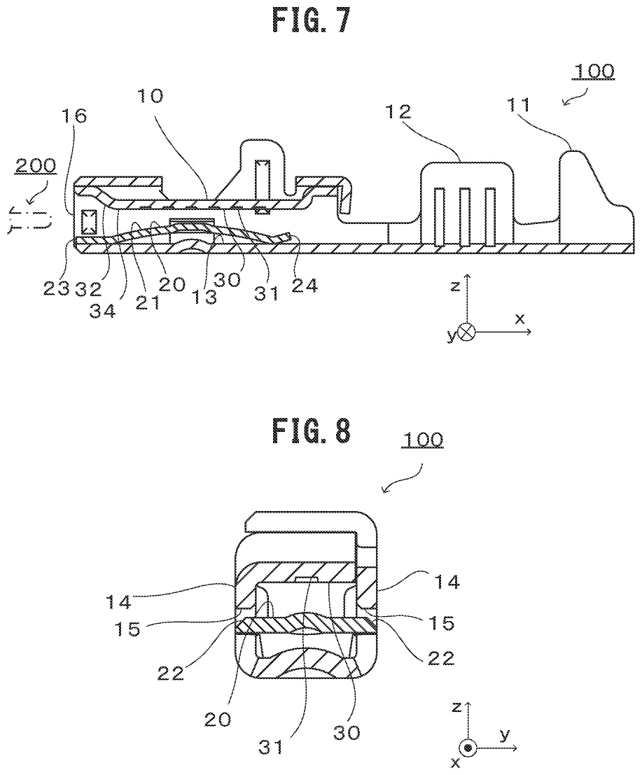

As illustrated in FIG. 7, the body 10 is a female terminal formed by bending working of a conductive member such as a metal plate, and has a cylindrical shape. The body 10 includes: a coating fixer 11 with which the insulating portion of a conductive wire is fixed; and a conductor swager 12 for press-bonding and fixing the conductor portion of the conductive wire. A surface of the body 10 preferably includes a conductive coating layer. The conductive coating layer includes a tin layer or a tin alloy layer. Moreover, a contact region 30 that comes into contact with the mating terminal 200, and a slope 32 that guides the mating terminal 200 to the contact region 30 are formed on the inner wall of the body 10. The slope 32 slopes with respect to a plane on which the contact region 30 is formed.

The coating fixer 11 presses an end of the insulated coated portion of an electric wire by swaging, and protects connection between the conductor swager 12 and a core wire from pull-out force. The conductor swager 12 is press-fitted and electrically connected to the conductive core wire of the electric wire by swaging.

The elastic contact plate 20 is arranged in the interior of the body 10, and presses the mating terminal 200 against the contact region 30. The elastic contact plate 20 includes an arch-shaped plate spring arranged along the longitudinal direction (x-axis direction) of the body 10. The elastic contact plate 20 includes: an arch-shaped plate spring portion 21; and ears 22 illustrated in FIG. 1. The ears 22 protrude from both sides of the central portion in the x-axis direction of the plate spring portion 21 to sides (y-axis direction). A leading end 23 and a rear end 24 of the elastic contact plate 20 are supported by an inner wall 13 of the body 10, and the ears 22 located in the central portion fit to notched portions 15 formed on both side walls 14 of the body 10, as illustrated in FIG. 8. The ears 22 fit to the notched portions 15, whereby the elastic contact plate 20 is inhibited from moving in the x-direction. Moreover, the ears 22 can move in the z-direction, whereby insertion of the mating terminal 200 allows the elastic contact plate 20 to be bent, and the inserted mating terminal 200 is sandwiched between the elastic contact plate 20 and the contact region 30 formed to face the elastic contact plate 20. Moreover, the ears 22 fit to the notched portions 15, whereby the elastic contact plate 20 is inhibited from coming into contact with the contact region 30, and a gap between the elastic contact plate 20 and the contact region 30 are maintained even when the leading end 23 and the rear end 24 are free ends.

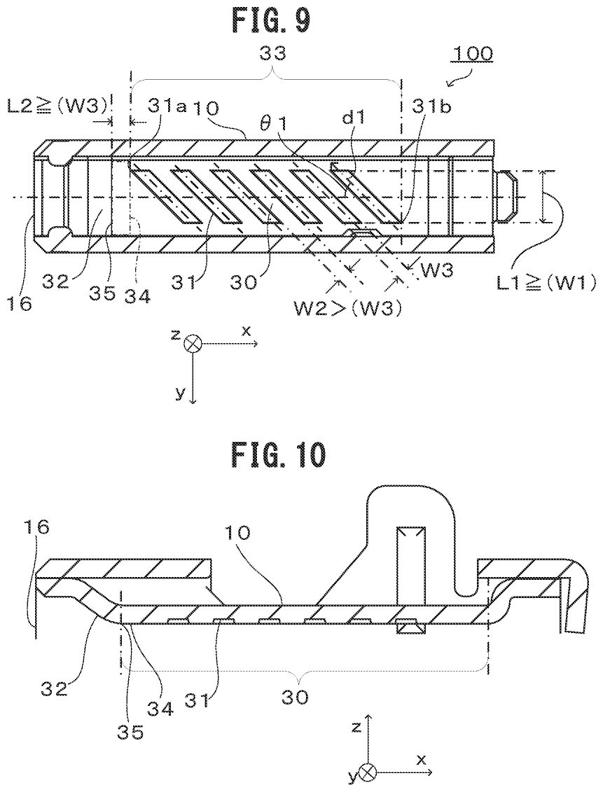

The contact region 30 is a portion that is formed on the inner wall of the body 10, and comes into contact with the mating terminal 200. As illustrated in FIG. 9, a plurality of grooves 31 extending in a direction (second direction) dl intersecting the x-direction (first direction) in which the mating terminal 200 is inserted are formed on the contact region 30. The plurality of grooves 31 is preferably arranged at equal spacings. Moreover, the plurality of grooves 31 is preferably arranged in parallel to each other. Moreover, a spacing W2 between the grooves 31 adjacent to each other is preferably greater than the width W3 of each of the grooves 31 (W2>W3). Moreover, a narrow-angle θ1 between the x-direction and the direction d1 in which the plurality of grooves 31 extend is 45 degrees. The length L1 in the y-direction of each of the plurality of grooves 31 is not less than the width W1 of the mating terminal 200 (L1≥W1). Moreover, the contact region 30 includes: a groove-formed region 33; and a groove-unformed region 34 as a portion in which any of the grooves 31 is not formed in the end closest to an inlet 16 of the body 10 into which the mating terminal 200 is inserted.

The groove-formed region 33 refers to a region in which the grooves 31 intersect a cross section orthogonal to the x-direction, and is specifically a region between an end 31a of the groove 31 closest to the inlet 16 of the body 10 and an end 31b of the groove 31 farthest from the inlet 16 in the x-direction. The groove-unformed region 34 refers to a portion in which any of the grooves 31 does not intersect a cross section orthogonal to the x-direction, and is specifically a region between the end 31a of the groove 31 closest to the inlet 16 of the body 10 and an edge 35 closest to the inlet 16 of the body 10 in the contact region 30. The narrow-angle θ1 between the x-direction and the direction dl in which the plurality of grooves 31 extends is 45 degrees, whereby an optional cross section, illustrated in FIG. 8, orthogonal to the x-direction in the groove-formed region 33 intersects one or two of the grooves 31. The formation of the grooves 31 in the contact region 30 can prevent a worn powder of the conductive coating layer from dropping in (adhering to) the grooves 31 and can prevent the worn powder from gathering between the contact region 30 and the mating terminal 200.

In the x-direction, the length L2 of the groove-unformed region 34 in the end is not less than the width W3 of each of the grooves 31 (L2≥W3). The contact region 30 is a flatly formed portion as illustrated in FIG. 10, and the edge 35 closest to the inlet 16 of the body 10 in the contact region 30 is a boundary of the slope 32 that slopes with respect to a flat plane on which the contact region 30 is formed. The groove-unformed region 34 is formed on the contact region 30, whereby the conductive coating layer of the contact region 30 or the mating terminal 200 is inhibited from being cut by the grooves 31, and insertion force is prevented from increasing. Moreover, a cross section of each of the grooves 31 has a trapezoidal shape.

A method of inserting the mating terminal 200 into the terminal 100 will now be described.

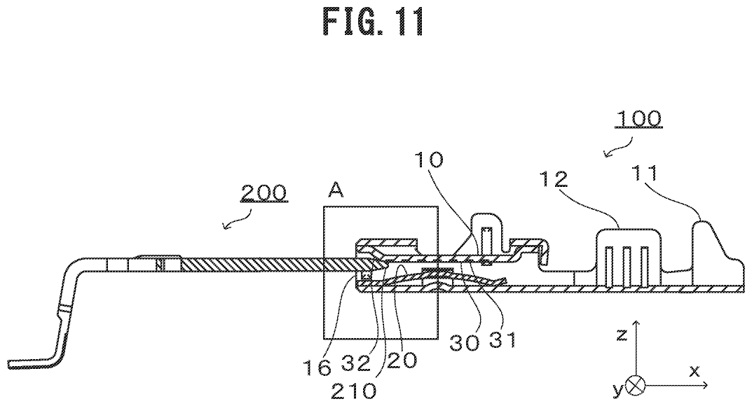

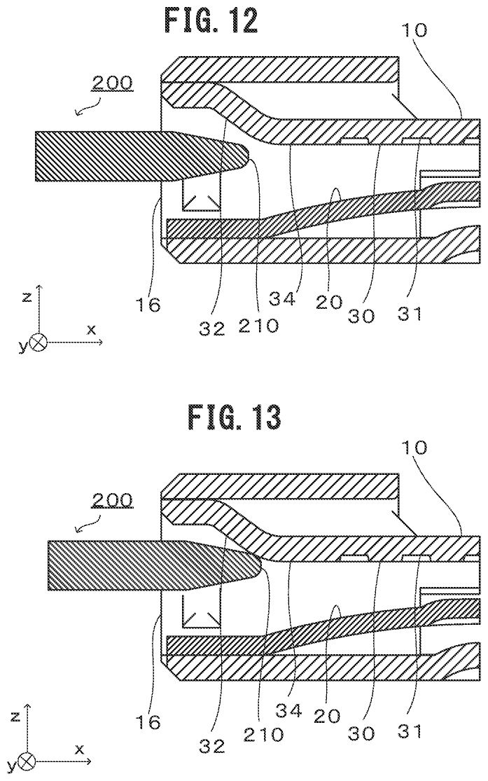

First, an operator inserts a leading end 210 of the mating terminal 200 from the inlet 16 of the terminal 100, as illustrated in FIGS. 11 and 12.

When the leading end 210 of the mating terminal 200 is inserted from the inlet 16 of the terminal 100, the leading end 210 comes into contact with the slope 32, as illustrated in FIG. 13. As a result, the leading end 210 of the mating terminal 200 is easily guided to the contact region 30.

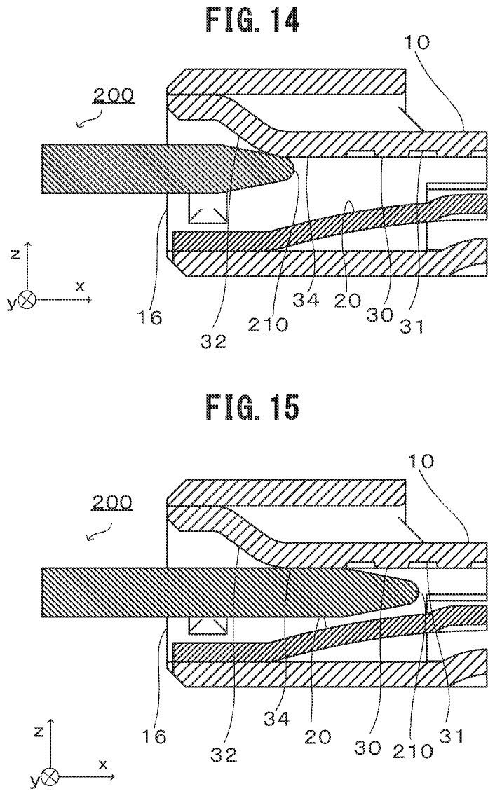

Further, when the leading end 210 of the mating terminal 200 is inserted into the terminal 100, the leading end 210 of the mating terminal 200 is guided to the groove-unformed region 34 in the contact region 30, as illustrated in FIG. 14. The formation of the groove-unformed region 34 in the contact region 30 inhibits the conductive coating layer of the contact region 30 or the mating terminal 200 from being cut by the grooves 31, and prevents a worn powder including the shavings of the coating layer from being generated.

Further, when the mating terminal 200 is inserted into the terminal 100, the leading end 210 of the mating terminal 200 is guided to the groove-formed region 33 in the contact region 30, as illustrated in FIG. 15. The formation of the grooves 31 in the contact region 30 can prevent a worn powder of the conductive coating layer from dropping in (adhering to) the grooves 31 and can prevent the worn powder from gathering between the contact region 30 and the mating terminal 200.

Further, when the mating terminal 200 is inserted into the terminal 100, the mating terminal 200 is connected to the terminal 100.

As described above, in the terminal 100 of the present embodiment, the plurality of grooves 31 is formed on the contact region 30, whereby the mating terminal 200 can be inserted with relatively low force. The force with which the mating terminal 200 is inserted into terminal 100 is caused by frictional force between the contact region 30 and the mating terminal 200. Frictional force is expressed by the sum of adhesion friction, friction caused by digging, and an elastic hysteresis loss. When tin layers are formed as the coating layers on the surfaces of the terminal 100 and the mating terminal 200, the tin layers come into contact with each other while the mating terminal 200 is inserted into the terminal 100, true contact surfaces (fine contact surfaces that actually come into contact with each other) adhere to each other, and a portion in which the tin layers adhered to each other is then going to be separated from the terminal 100 or the mating terminal 200. Then, when the adhered portion is dislocated from the terminal 100 or the mating terminal 200 while the tin layers come into contact with each other, a worn powder is formed. Then, the worn powder digs another tin layer due to insertion of the mating terminal 200, whereby friction is caused by the digging. Moreover, the same also applies when tin alloy layers are formed as the coating layers. In the terminal 100 of the present embodiment, the formation of the plurality of grooves 31 in the contact region 30 can prevent a worn powder of the conductive coating layer from dropping in (adhering to) the grooves 31 and can prevent the worn powder from gathering between the contact region 30 and the mating terminal 200. Accordingly, in the terminal 100 according to the present embodiment, friction caused by digging can be reduced, and force with which insertion is performed can be reduced. Moreover, gathering of a worn powder of the conductive coating layer in the grooves 31 between the terminal 100 and the mating terminal 200 due to dropping of the worn powder is prevented, whereby the terminal 100 and the mating terminal 200 can directly come into contact with each other, and contact resistance can be reduced.

Accordingly, in the terminal 100 of the present embodiment, a relative reduction in force with which the mating terminal 200 is inserted enables the number of poles in one connector to be increased to enable the number of connectors to be reduced. An increase in the number of poles, caused by an increase in the number of electric wiring lines, and downsizing of electronic components, demanded in connectors due to driven digitalization in automobiles, can be achieved. Moreover, a lever-type connector can be replaced with a usual connector without a lever depending on the number of poles, and therefore, the connector can be downsized. Moreover, contribution to a reduction in cost due to a reduction in the number of components can also be achieved.

Moreover, the contact region 30 has a structure in which a cross section, illustrated in FIG. 8, orthogonal to the x-direction intersects one or two of the grooves 31, whereby in a case in which the leading end 210 of the mating terminal 200 is in the groove-formed region 33, the leading end 210 always comes into contact with the grooves 31 at the time of insertion of the mating terminal 200, to thereby enable force with which the mating terminal 200 is inserted to be constant. In contrast, when each of the grooves 31 has a shape of extending in the y-direction, the leading end 210 of the mating terminal 200 alternately passes through portions with and without the grooves 31. Therefore, force with which the mating terminal 200 is inserted may repeatedly become high or low, and high force may be required for connecting the connector by an operator.

Moreover, the terminal 100 includes the slope 32, whereby the leading end 210 of the mating terminal 200 comes into contact with the slope 32 to thereby easily guide the leading end 210 of the mating terminal 200 to the contact region 30. Moreover, the formation of the groove-unformed region 34 in the contact region 30 inhibits the conductive coating layer of the contact region 30 or the mating terminal 200 from being cut by the grooves 31, and prevents a worn powder including the shavings of the coating layer from being generated. As a result, the terminal 100 enables the mating terminal 200 to be inserted with relatively low force.

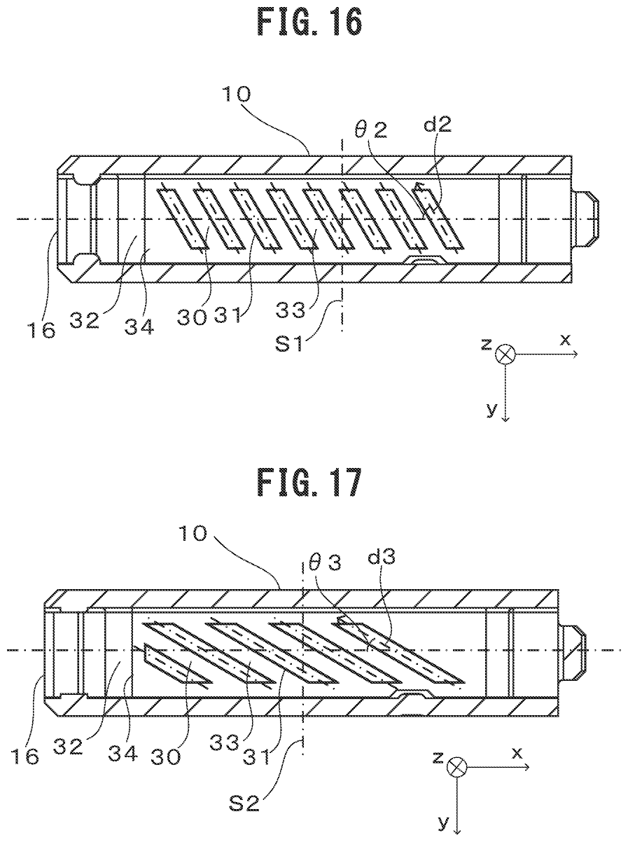

(Alternative Examples) In the embodiment described above, an example is described in which the narrow-angle θ1 between the x-direction and the direction dl in which each of the plurality of grooves 31 formed on the contact region 30 extends is 45 degrees. The plurality of grooves 31 formed on the contact region 30 preferably extends in a direction intersecting the x-direction in which the mating terminal 200 is inserted. For example, with regard to the plurality of grooves 31, a plurality of grooves 31 that extends in a direction d2 intersecting the x-direction, in which a mating terminal 200 is inserted, at a narrow-angle θ2 of 60 degrees may be formed, as illustrated in FIG. 16. In such a case, a cross section S1 orthogonal to the x-direction in a groove-formed region 33 intersects one of the grooves 31. With regard to the plurality of grooves 31, a plurality of grooves 31 that extends in a direction d3 intersecting the x-direction, in which a mating terminal 200 is inserted, at a narrow-angle θ3 of 30 degrees may be formed, as illustrated in FIG. 17. In such a case, a cross section S2 orthogonal to the x-direction in a groove-formed region 33 intersects two of the grooves 31. The cross section S1 or S2 intersects one or two of the grooves 31 in the groove-formed region 33 when the narrow-angle θ2 or θ3 between the x-direction and the direction d2 or d3 in which the plurality of grooves 31 extends is 30 degrees or more and 60 degrees or less, as described above. Therefore, the narrow-angle θ2 or θ3 is preferably 30 degrees or more and 60 degrees or less.

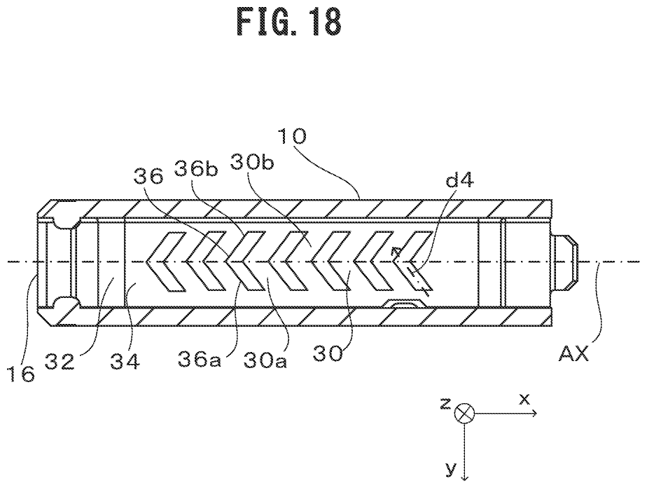

As illustrated in FIG. 18, a contact region 30 may include a first contact region 30a and a second contact region 30b into which the contact region 30 is divided by a virtual line AX extending in the x-direction. In such a case, a plurality of first grooves 36a extending in a direction d4 intersecting the x-direction is formed on a surface of the first contact region 30a. A plurality of second grooves 36b, formed to be line-symmetric, across the virtual line AX as a symmetry axis, with respect to the plurality of first grooves 36a formed on the first contact region 30a, is formed on the second contact region 30b. In such a manner, grooves 36 each having a V-shape which is bilaterally symmetric with respect to the x-direction are formed.

In the embodiment described above, an example is described in which the conductive coating layer includes a tin layer or a tin alloy layer. The coating layer is preferably used for, for example, decreasing contact resistance between the contact region 30 and the mating terminal 200. The coating layer may be a thin film layer of silver, silver alloy, gold, gold alloy, or the like.

In the embodiment described above, an example is described in which the elastic contact plate 20 includes an arch-shaped plate spring arranged along the longitudinal direction of the body 10. The elastic contact plate 20 can preferably press the mating terminal 200 against the contact region 30, and may be formed of a metal plate connected to the body 10.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is used for electrically connecting an electronic circuit including an electronic circuit for automobile use.

### REFERENCE SIGNS LIST

10 Body
11 Coating fixer
12 Conductor swager
13 Inner wall
14 Side wall
15 Notched portion
16 Inlet
20 Elastic contact plate
21 Plate spring portion
22 Ear
23 Leading end
24 Rear end
30 Contact region
30a First contact region
30b Second contact region
31 Groove
31a, 31b End
32 Slope
33 Groove-formed region
34 Groove-unformed region
35 Edge
36 Groove
36a First groove
36b Second groove
100 Terminal
200 Mating terminal
210 Leading end
AX Virtual line
L1, L2 Length
W1, W3 Width
W2 Spacing
d1 to d4 Direction
S1, S2 Cross section
θ1 to θ3 Narrow-angle

What is claimed is:

1. A terminal comprising:
a body that comprises a cylindrical shape into which a mating terminal is inserted, and comprises, in an inner wall, a contact region that comes into contact with the mating terminal; and
an elastic contact plate that presses the mating terminal against the contact region,
wherein a plurality of grooves that extends in a second direction intersecting a first direction in which the mating terminal is inserted are formed in the contact region.

2. The terminal according to claim 1, wherein the plurality of grooves is arranged at an equal spacing.

3. The terminal according to claim 1, wherein the plurality of grooves is arranged in parallel to each other.

4. The terminal according to claim 1, wherein a spacing between the grooves is greater than a width of each of the grooves.

5. The terminal according to claim 1, wherein a cross section orthogonal to the first direction in the contact region intersects one or two of the grooves.

6. The terminal according to claim 1, wherein the plurality of grooves extends in a direction sloping at an angle of 30 degrees or more and 60 degrees or less with respect to the first direction.

7. The terminal according to claim 1, wherein the contact region comprises a portion in which any of the grooves is not formed in an end closest to an inlet of the body into which the mating terminal is inserted.

8. The terminal according to claim 7, wherein a length of the portion in which any of the grooves is not formed in the end in the first direction is not less than the width of each of the grooves.

9. The terminal according to claim 7, further comprising a slope that is connected to the end in the contact region, guides the mating terminal to the contact region, and slopes with respect to a plane on which the contact region is formed.

10. The terminal according to claim 1, wherein
the contact region comprises a first contact region and a second contact region into which the contact region is divided by a virtual line extending in the first direction,
a plurality of first grooves extending in the second direction is formed on a surface of the first contact region, and
a plurality of second grooves, formed to be line-symmetric, across the virtual line as a symmetry axis, with respect to the plurality of first grooves formed on the first contact region, is formed on the second contact region.

11. The terminal according to claim 1, wherein at least one of the mating terminal or the contact region comprises a conductive coating layer.
